(19) United States
(12) Patent Application Publication
(10) Pub. No.: US 2007/0042285 A1
(43) Pub. Date: Feb. 22, 2007

(54) Electrostatic image developing toner and image forming method

(76) Inventors: Ryuji Kitani, Tokyo (JP); Kenji Yamane, Sagamihara-shi (JP); Yasuko Yamauchi, Tokyo (JP); Kouji Sugama, Tokyo (JP)

Correspondence Address: CANTOR COLBURN, LLP, 55 GRIFFIN ROAD SOUTH, BLOOMFIELD, CT, 06002, US

(21) Appl. No.: 11/474,909

(22) Filed: Jun. 26, 2006

(30) Foreign Application Priority Data
Aug. 22, 2005 (JP) JP2005-239732

(51) Int. Cl. G03G 9/08

(52) U.S. Cl. 430/110.2; 430/110.3

(57) ABSTRACT

An electrostatic image developing toner is disclosed, comprising toner particles composed of a core containing resin and a colorant and a shell containing a resin, wherein the standard deviation of shape factor SF-1 of the toner particles and the standard deviation of shape factor SF-2 fall within the specific range, and the ratio of maximum thickness of the shell to minimum thickness falls within the specific range.

### TECHNICAL FIELD

The present invention relates to toners for use in electrophotographic image forming apparatuses and in particular to toners having a core/shell structure.

### RELATED ART

Along with the progress of digital techniques, precise image reproduction of microdot images at a level of 1200 dpi (dpi: the number of dots per inch or 2.54 cm) has been required in the field of electrophotographic image forming techniques, such as for copiers and printers. Reduction of toner particle size has been studied as a means to achieve precise reproduction of such minute images. There have been noted chemical toners such as polymerization toners the physical properties of which can be controlled in the preparation stage thereof, as described, for example, in JP-A No. 2000-214629 (hereinafter, the term, JP-A refers to Japanese Patent Application Publication).

Recently, techniques for reducing electric power consumption have been studied from the viewpoint of global environment concerns. Chemical toners are also noted as a means to overcome that problem. Examples thereof include a toner technique in which a low melting wax is allowed to be included in a polymerization toner, thereby enabling formation of fixed images at a lower temperature, as described, for example, in JP-A No. 2001-42564.

To perform stable image formation, it has been required to design a toner in which constituents such as colorants and releasing agents do not leave the toner surface. Accordingly, there was proposed a toner having a structure covering layer including constituents such as colorants or a releasing agents with resin, a so-called core/shell structure.

Techniques for preparing a toner of such a core/shell structure include a technique in which particulate resin is melted onto the surface of core particles prepared by allowing resin microparticles and a colorant to coalesce with each other and melt to form a core/shell structure, as described, for example, in JP-A No. 2002-116574.

Toners of a core/shell structure require constituents contained in the core to efficiently bleed-out onto the toner surface. Accordingly, there has been studied the shell thickness whereby toner constituents efficiently bleed out onto the toner surface. For instance, there is a technique regarding a toner preparation method in which the shell thickness is at a level of several tens to several hundreds of nm, as described in JP-A Nos. 2004-191618 and 2004-271638.

Recently, in image forming techniques of electrophotographic systems, there is the tendency of reducing electric power consumption of printers or copiers from the viewpoint of environmental concerns at the time of image formation and cost reduction in offices. A technique to enable fixing at a lower temperature than the status quo is noted as one of the response tactics thereof. Further, a printer capable of rapid image formation is strongly desired by consumers, for example, printers capable of outputting approximately 50 sheets of A4 size per minute have appeared on the market.

However, currently available toners of a core/shell structure had difficulties when applied to image formation in which fixing is performed at a low temperature and print output is at a high-speed. For instance, when using a toner with a shell thickness at a level as described in the foregoing JP-A Nos. 2004-191618 and 2004-271638, it was difficult to achieve sufficient releasing performance, easily causing offset. A shortened fixing time as well as a lowered fixing temperature rendered it difficult to provide sufficient fixing strength to the toner.

### SUMMARY OF THE INVENTION

It is an object of the present invention to provide a toner of a core/shell structure which can form toner images exhibiting sufficient fixing strength even when using an image forming apparatus which fixed images at a high rate and a low temperature and can also achieve stable toner release performance without causing offsetting.

Thus, one aspect of the invention is directed to an electrostatic image developing toner comprising toner particles comprised of a core containing at least a resin and a colorant and having thereon a shell, wherein the toner particles exhibit a standard deviation of shape factor (SF-1) of 0.05 to 0.20 and a standard deviation of shape factor (SF-2) of 0.05 to 0.20, and the shell meeting the following equation:
1.5≦(Lmax)/(Lmin)≦50
wherein (Lmax) is an average of maximum thickness of the shell of the toner particles and (Lmin) is an average of minimum thickness of the shell.

### BRIEF EXPLANATION OF THE DRAWINGS

FIGS. 1a and 1b illustrate a toner particle of a core/shell structure, relating to the invention.

FIG. 1c illustrates a conventional toner particle of a core/shell structure.

FIG. 2 illustrates a section of an image forming apparatus in which a toner relating to the invention is usable.

FIG. 3 illustrates a section of a heating roll type fixing device usable in the invention.

### DETAILED DESCRIPTION OF THE INVENTION

While the present invention will hereinafter be described in connection with preferred embodiments thereof, it will be understood that it is not intended to limit the invention to those embodiments. On the contrary, it is intended to cover all alternatives, modifications, and equivalents as may be included within the spirit and scope of the invention as defined by the appending claims.

In the invention, it was found that even when the shell thickness was not uniform, the toner particles achieved relatively uniform shape, whereby superior toner images were be obtained even when image formation was performed at a high a rate and a temperature lower than usual. Thus, the toner afore-mentioned can obtain toner images exhibiting stable fixing strength even when fixed at a lower temperature than usual, enabling display of stable releasing performance without causing offseting.

In the toner of the invention, core constituents such as a colorant or a releasing agent are not released at the site of a thin shell, enabling superior image formation without causing image defects such as fogging.

The reason for the toner of the invention enabling to form stable toner images at a higher rate and a temperature lower than usual is assumed to be due to variation in shell thickness which enables a releasing agent contained in the core to bleed out onto the toner surface.

In the toner of the invention, the shell thickness is made non-uniform on one side but the toner shape is made uniform, forming sites at which a releasing agent bleeds out relatively easy onto the toner surface and sites at which the releasing agent bleeds out with relatively difficulty, thereby overcoming imaging problems in high-speed printing at a relatively low temperature.

As a result of extensive study of the above-mentioned problems, it was found that superior toner image formation was achieved when fixing at a high speed and a lower temperature than usual, using a toner comprising toner particles formed of a core containing a resin and a colorant and having a shell on the core in which the standard deviation of a shape factor SF-1 of the toner particles, denoted as (SF-1)ₜ is within the range of 0.05 to 0.20 and the standard deviation of a shape factor SF-2 of the toner particles, denoted as (SF-2)ₜ is within the range of 0.05 to 0.20; the maximum shell thickness, denoted as Lmax and the minimum shell thickness, denoted as Lmin meet the following relationship (1):
1.4≦(Lmax/Lmin)≦50 (1)
wherein Lmax and Lmin are respectively the maximum shell thickness and the minimum shell thickness of the shells. It was designed by the inventors that nonuniformity of the shell thickness provided sites at which a releasing agent easily bled out onto the toner surface. Thus, it was aided that a core needed to be sufficiently covered with a shell so that a releasing agent or a colorant contained in the core was not liberated from the core; at the same, thin shell sites were formed, from which the releasing agent easily bled out.

As mentioned above, it was discovered that these specifications of the shape factor of the toner particles and the relationship between the maximum and minimum shell thicknesses enabled obtaining toner images exhibiting stable strength without causing offset in image formation conducted at a high speed and fixed at a low temperature. Further, the toner satisfying the foregoing conditions can achieve superior image formation with no image defect such as fogging, while no constituent contained in the core is liberated from thin shell sites.

In the invention, shape uniformity of toner particles is achieved, while also providing variations in shell thickness. Preparation of a toner satisfying conditions which were apparently contradictory to each other, were achieved by controlling preparation conditions of the toner. Specifically, when resin microparticles are allowed to coagulate with each other to form core particles, control of a coagulation temperature or a coagulation time controls the coagulation process or fusion of resin microparticles to form deformed cores of poor circularity. Further thereto, a particulate resin is added to allow a shell to fuse onto the core surface with controlling the time, whereby toner particles of a uniform shape, exhibiting a certain extent of circularity can be obtained. In the invention, controlling coagulation of resin microparticles in the core preparation and fusion of a resin used for shelling onto the core surface makes it feasible to prepare the toner described above.

Measurements and standard deviations of shape factors SF-1 and SF-2 of toner particles or core particles can be conducted as below. The shape factor SF-1 indicates an extent of roundness (or circularity) of particles and the shape factor SF-2 indicates the extent of ruggedness (or roughness) or recesses (or depressions) of toner or core particles, which are defined in the equation described below.

A greater value of shape factor SF-1 indicates a particle of a more rounded shape, while a greater value of shape factor SF-2 indicates a particle having enhanced ruggedness and a deformed shape.

The shape factor can be determined in a manner that at least 100 random toner particles are photographed using an electron-microscope at a magnification factor of 2,000 and the obtained electron-micrograph is analyzed using image analysis processor LUZEX AP. Shape factors SF-1 and SF-2 of toner particles, and the standard deviation (denoted as SD) thereof are defined as below:
SF-1=[(maximum diameter of toner particle)²/(projected area of toner particle)]×(π/4)
SF-2=[(circumference of toner particle)²/(projected area of toner particle)]×(1/4π)
SD={sum of [(measured value)−(average value)]²/(number of data)}^{1/2}
In the foregoing, when projection of a toner particle onto the plane is sandwiched between two parallel lines, the maximum diameter is the width of the particle at the time when the spacing between two parallel lines is the greatest; and the projected area is the area of the toner particle projected onto the plane. Further, the average value used to calculate the standard deviation refers to the number-average value of SF-1 or SF-2 values for at least random 100 toner particles.

The shape factors SF-1 and SF-2 of toner particles relating to the invention are each on the average preferably in the range of from 1.10 to 1.50. The standard deviation of shape factor SF-1 or SF-2 of the toner particles are each in the range of from 0.05 to 0.20 and preferably 0.10 to 0.15. It was confirmed that a standard deviation falling within the foregoing range rendered it difficult to cause fogging. This is assumed to be due to controlling the toner shape to result in uniform electrostatic-charging property, rendering it difficult to cause fogging.

The shell thickness can be determined from a transmission electron-micrograph of the section of a toner particle. Electron-microscopic observation can be conducted using a conventionally known transmission electron microscope, for example, LEM-2000 type (produced by Topcon Co.) or JEM-2000 FX (produced by Nippon Denshi Co.).

Initially, toner particles are dispersed in cold setting epoxy resin, buried therein, dispersed in ca. 100 nm stainless steel particle and then subjected to pressure molding. The obtained block is optionally dyed with triruthenium tetraoxide or in its combination with triosmium tetraoxide and sliced using a microtome provided with a diamond cutter. The sliced sample is photographed using a transmission electron microscope (TEM) at a magnification factor of 10,000 to observe the cross-section of the toner particle.

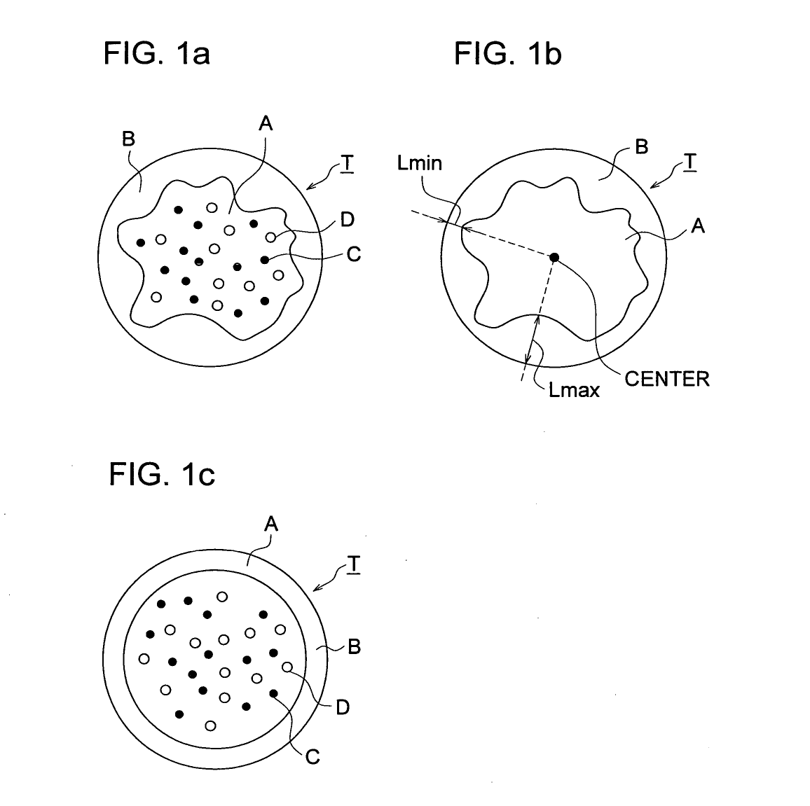

Subsequently, in the photographed electron-micrograph, a boundary line between a core and a shell is clarified, while visually observing the colorant or wax-existing region. A straight line is drawn from the center (center of gravity) of a toner particle toward the surface and the distance between the boundary line and the surface (which is a shell thickness, expressed in nm) is measured. Of the thus measured values, the maximum value is defined as Lmax and the minimum value is defined as Lmin. The toner particles of the invention meet the following equation (1):
1.5≦(Lmax)/(Lmin)≦50.0 (1)
where (Lmax) is an average of Lmax values of the toner particles and (Lmin) is an average of Lmin values of the toner particles. In the foregoing TEM photography, at least 10 toner particles are photographed to determine values of (Lmax) and (Lmin). When the shell thickness is extremely close to zero, the value of Lmin is assumed to be 10 nm (i.e., Lmin=10 nm). FIG. 1b illustrates the maximum thickness Lmax and the minimum thickness Lmin of the shell.

The average maximum shell thickness, designated as (Lmax) is preferably in the range of 100 to 500 nm. When image formation is carried out at a relatively high speed and a relatively low temperature, a shell thickness falling within this range can allow a releasing agent to be optimally eluted from the core onto the toner surface, resulting in superior releasing capability and fixability.

The average minimum shell thickness, designated as (Lmin) is preferably in the range of 10 to 100 nm. A minimum shell thickness falling within this range allows a releasing agent to efficiently elute and can stably keep a colorant within the core without being liberated, leading to superior toner image formation without causing an effect of fogging on images.

The ratio of the average maximum shell thickness to the minimum shell thickness (Lmax)/(Lmin) is in the range of from 1.5 to 50.0, and preferably from 10.0 to 40.0.

The present invention employs the difference in elution of a releasing agent, resulting from the difference in shell thickness. A shell thickness ratio falling within the foregoing range can contribute to offset resistance even when fixed at a lower temperature than usual, whereby occurrence of winding can be avoided. Further, a releasing agent is homogeneously eluted from the core, resulting in stable fixing performance.

When the toner particles of the invention satisfy the following equation (2), advantages of the invention have come into effect:
(shape factor SF-2 of cores)>(shape factor SF-2 of toner particle) (2)
wherein (shape factor SF-2 of cores) represents an average shape factor SF-2 of cores and (shape factor SF-2 of toner particle) represents an average shape factor SF-2 of toner particles.

The shape factor SF-2 of core is defined similarly to the afore-defined shape factor SF-2 of toner particle, as below.
SF-2 of core=[(circumference of core)²/(projected area of core)]×(1/4π)
The shape factor SF-2 of core can be determined using a sectional transmission electron-micrograph (TEM) of at least 10 random toner particles and image analysis processor LUZEX AP. In the foregoing equation (2), (shape factor SF-2 of cores) is the average value of cores of at least 10 toner particles, and (shape factor SF-2 of toner particles) is the average value of at least 10 toner particles. Determination can be conducted similarly to the determination of shape factor of toner particle, as afore-mentioned.

The shape factor SF-2 of core is preferably in the range of 2.0 to 10.0.

The toner particles of the invention each have a core/shell structure comprising a core o composed of a resin and a colorant, and a shell layer which covers the core portion with a particulate resin. FIG. 1a illustrates a toner particle having a core/shell structure relating to the invention, while FIG. 1c illustrates a toner particle having a conventional core/shell structure. In the drawings, T designates a toner particle, A designates a core, B designates a shell, C designates a colorant and D designates a wax. As shown in the drawings, a toner particle having a core/shell structure exhibits a structure in which shell B covers the core surface. As shown in FIG. 1a, the toner particles exhibit variations in shell thickness, so that the toner surface exhibits unevenness. In other words, adding a particulate resin to core particles exhibiting a high shape factor value, the particulate resin is fused onto the surface of the core particles, ultimately forming uniform toner particles. In the toner of the invention, resin particles are coagulated and fused onto the deformed core surface having a deformed shape to form a shell. Accordingly, the formed toner particles exhibit relatively rounded form.

The shape of toner particles of the invention preferably exhibits the following characteristic: a volume-based median diameter is in the range of 2.0 to 7.0 μm, an average circularity is in the range of 0.920 to 0.975, and a shell has a thickness of 10 to 500 nm.

The core of the core/shell toner particles of the invention can be obtained by allowing a composite resin having a multi-layer structure, obtained by emulsion polymerization, more specifically, multistage polymerization to be coagulated and fused together with colorant particles (or colored resin particles) in the presence of a coagulant. Onto the thus coagulated composite resin particles or colored resin particles, shelling is performed using a separately prepared resin particle dispersion to form a shell layer on the core. Thus, performing shelling onto the core surface forms a shell layer formed of a particulate resin to form colored particles.

Further, external additives are added onto the formed shell surface to form core/shell toner particles.

The weight ratio of the shell (which may be composed of a single layer or plural layers) is preferably 10% to 30%, based on the core.

In the toner of the invention, the glass transition temperature (or glass transition point) of the resin forming the core is preferably lower than that of the resin forming the shell.

The glass transition temperature of a resin forming the core or shell of the toner of the invention can be determined using a differential scanning calorimeter (DSC), in which the intersection of a slope at an endothermic peak with the base line is defined as the glass transition temperature. Concretely, a sample is heated to a temperature of 100° C. and after allowed to stand at that temperature for 3 min., the sample is cooled to room temperature at a rate of 10° C./min. Subsequently, when the sample is remeasured at a temperature-increasing rate of 10° C./min., the intersection of an extension of the base-line of the side lower than the glass transition temperature and a tangent line exhibiting the maximum slope between the rising portion of a peak and the peak itself, is defined as the glass transition temperature. Measurement is conducted using, for example, DSC-7, produced by Parkin Elmer.

In the toner of the invention, the softening point of a resin constituting the core is preferably lower than that of a resin constituting the shell.

The softening point of a resin constituting the core or shell can be determined using a flow tester. Specifically, using flow tester CFT-500 (produced by Shimazu Seisakusho Co., Ltd.), when a sample of 1 cm³ is melt-flowed under conditions of a pore diameter of 1 mm and a length of 1 mm of a die, a load of 20 kg/cm², a temperature-increasing rate of 6° C./min and the initial temperature for the temperature-increase of 50° C., the temperature corresponding to half of the height of from the flow-starting point to the flow-completion point is defined as the softening point.

A resin constituting the core of the toner of the invention preferably has a weight-average molecular weight (Mw) of 0.3×10⁴ to 4×10⁴ and a resin constituting the shell preferably has a weight-average molecular weight (Mw) of 0.8×10⁴ to 20×10⁴. The molecular weight of a resin constituting the toner of the invention can be determined for example, by gel permeation chromatography (GPC) using THF (tetrahydrofuran) as a solvent. Specifically, to 1 mg of a measured sample, 1 ml of THF is added and stirred using a magnetic stirrer under room temperature until sufficiently dissolved. Subsequently, after filtering through a membrane filter having a pore size of 0.45 to 0.50 μm, a sample solution is injected into the GPC. Measurement is conducted under the condition that after being stabilized at 40° C., THF flows at a rate of 1 ml per min. and 100 μl of a sample having a concentration of 1 mg/ml is injected to conduct the measurement. Combined use of commercially available polystyrene gel columns is preferred. Examples thereof include combinations of Shodex GPC KF-801, 802, 803, 804, 805, 806, and 807 (a product of Showa Denko Co., Ltd.); the combination of TSK gel G1000H, G2000H, G3000H, G4000H, G5000H, G6000H, G7000H and TSK guard column (a product of TOSOH CORP.). A refractive index detector (IR detector) or a UV detector is preferred as the detector used. In the molecular weight measurement of a sample, the molecular weight distribution of the sample is calculated using a calibration curve prepared by using monodisperse polystyrene standard particles. About 10 points are preferably used as polystyrene for the calibration curve.

The volume-based median diameter (volume D 50% diameter) of toner particles of the invention is preferably 2.0 to 7.0 μm. The volume-based can be measured and calculated using a Coulter Multisizer III (Beckmann Coulter Co.) which was connected to a computer system for data processing (Beckmann Coulter Co.), according to the following procedure. To 20 ml of an aqueous surfactant solution (for example, a neutral detergent containing surfactant components is diluted to a factor of 10 with pure water) is added 0.02 g of a toner and dispersed with an ultrasonic homogenizer for 1 min. to prepare a toner dispersion. This toner dispersion is injected by a pipette into a beaker in which ISOTON II (Beckman Coulter Co.) within a sample stand has been placed until reaching a measurement concentration of 5% to 10%, and then, the measurement count is set to 2,500 and the measurement process is started. There is used 50 μm of the aperture diameter for the Coulter Multisizer.

In the manufacturing process of the toner of the invention, colored particles can be prepared with controlling the particle size, whereby toner particles of a small diameter can be prepared. Accordingly, uniform toner microparticles can be prepared, whereby microdot images, such as fine lines required in digital image reproduction can be precisely formed.

The toner particles of the invention preferably exhibit an average circularity of 0.920 to 0.975. The circularity is defined as follows:
Circularity={(circumference of a circle having an area equivalent to the projected area of a particle)/(a circumference of the projected particle)}.
The circularity of toner particles can be determined using FPIA-2100 (produced by Sysmex Co.). Concretely, toner particles are added into an aqueous surfactant solution, dispersed by ultrasonic for 1 min. and subjected to measurement using FPIA-2100. The measurement condition is set to HPF (high power flow) mode and measurement is conducted at an optimum concentration of the HPF detection number of 3,000 to 10,000.

The toner particles of the invention exhibit a form which has been made irregular to some extent so that the average circularity degree falls within the foregoing range. Such a form enhances heat transfer efficiency, leading to enhanced fixability and secured adhesion of external additives. Further, high resolution images can be obtained and even when printing is made in multi-sheets, particle fragmentation due to stress during usage is inhibited to obtain images of no fogging.

There will be described resin constituting the toner of the invention.

Resin constituting the core or shell of the toner can employ polymers obtained by polymerization of polymerizable monomers described below. Thus, a resin relating to the invention contains at least a polymer obtained by polymerization of at least one polymerizable monomer. Examples of such a monomer include styrene and derivatives thereof such as styrene, o-methylstyrene, m-methylstyrene, p-methylstyrene, α-methylstyrene, p-chlorostyrene, 3,4-dichlorostyrene, p-phenylstyrene, p-ethylstryene, 2,4-dimethylstyrene, p-tert-butylstyrene, p-n-hexylstyrene, p-n-octylstyrene, p-n-nonylstyrene, p-n-decylstyrene, p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethyl methacrylate, stearyl methacrylate, lauryl methacrylate, phenyl methacrylate, diethylaminoethyl methacrylate, dimethylaminoethyl methacrylate; acrylic acid esters and derivatives thereof such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and the like; olefins such as ethylene, propylene, isobutylene, and the like; halogen based vinyls such as vinyl chloride, vinylidene chloride, vinyl bromide, vinyl fluoride, and vinylidene fluoride; vinyl esters such as vinyl propionate, vinyl acetate, and vinyl benzoate; vinyl ethers such as vinyl methyl ether and vinyl ethyl ether; vinyl ketones such as vinyl methyl ketone, vinyl ethyl ketone, and vinyl hexyl ketone; N-vinyl compounds such as N-vinylcarbazole, N-vinylindole, and N-vinylpyrrolidone; vinyl compounds such as vinylnaphthalene and vinylpyridine; as well as derivatives of acrylic acid or methacrylic acid such as acrylonitrile, methacrylonitrile, and acryl amide. These vinyl based monomers may be employed individually or in combinations.

Further preferably employed as polymerizable monomers, which constitute the resin of the invention, are those having ionic dissociating groups in combination, and include, for instance, those having substituents such as a carboxyl group, a sulfonic acid group, and a phosphoric acid group, as the constituting groups of the monomers. Specifically listed are acrylic acid, methacrylic acid, maleic acid, itaconic acid, cinnamic acid, fumaric acid, maleic acid monoalkyl ester, itaconic acid monoalkyl ester, styrenesulfonic acid, allylsulfosuccinic acid, 2-acrylamido-2-methylpropanesulfonic acid, acid phosphoxyethyl methacrylate, 3-chloro-2-acid phosphoxyethyl methacrylate, and 3-chloro-2-acid phosphoxypropyl methacrylate.

Further, it is possible to prepare resins having a cross-linking structure, employing polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol methacrylate, and neopentyl glycol diacrylate.

Waxes usable in the toner of the invention are those known in the art. Examples thereof include polyolefin wax such as polyethylene wax and polypropylene wax; long chain hydrocarbon wax such as paraffin wax and sasol wax; dialkylketone type wax such as distearylketone; ester type. wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristarate, and distearyl meleate; and amide type wax such as ethylenediamine dibehenylamide and trimellitic acid tristearylamide.

The melting point of wax is usually in the range of 40 to 160° C., preferably 50 to 120° C. and more preferably 60 to 90° C. A melting point falling within the foregoing range can keep heat storage stability of the toner and perform stable image formation without causing offsetting even when fixed at a relatively low temperature. The wax content of the toner is preferably in the range of 1% to 30% by weight, and more preferably 5% to 20%.

Next, the preparation method of a toner used for developing electrostatic images will be described.

The toner is prepared via the following steps:

(1) dissolution/dispersion step of dissolving and/or dispersing a radical-polymerizable monomer,

(2) polymerization step of preparing resin microparticles,

(3) coagulation/fusion step of allowing resin microparticle and colorant particles to coagulate and fuse to form core particles (associated particles),

(4) first ripening step of ripening the associated particles with heat energy to control the particle form,

(5) shelling step of adding particulate resin used for a shell to a dispersion of the core particles (associated particles) to allow the resin used for a shell to be coagulated and fused onto the surface of the core particles to form colored particles exhibiting a core/shell structure,

(6) second ripening step for ripening the colored particles of a core/shell structure with heat energy to control the form of the colored particles,

(7) washing step of separating the colored particles from a cooled dispersion of colored particles to remove surfactants and the like from the colored particles;

(8) drying step of the washed colored particles, and optionally

(9) a step of adding external additives to the dried colored particles.

In the preparation of the toner of the invention, firstly, resin microparticles and colorant particles are coagulated with each other and fused to form colored particles as core particles. Then, particulate resin is added to a dispersion of the core particles to allow the particulate resin to coagulate and fuse onto the surface of the core particles to form colored particles having a core/shell structure. Thus, the toner particles of the invention are prepared by adding particulate resin to a dispersion of core particles prepared by various methods to be fused onto the core particles to form toner particles of a core/shell structure.

As afore-mentioned, toner particles each have variations in shell thickness and after completion of shelling, toner particles of a uniform shape result. To prepare toner particles having such a structure and shape, core particles are preferably made a rugged shape and particulate resin used for the shell is added thereto to perform shelling of the core particles. Shape control of the final toner particles is preferably performed during the shelling stage to provide the optimal shape.

Cores of the toner particles are prepared by coagulation and fusion of resin microparticles and colorant particles. The shape of core particles is controlled by adjusting the heating temperature in the coagulation/fusion step and the heating temperature and time in the first ripening step. Specifically, controlling the heating temperature in the coagulation/fusion step to a relatively low temperature retards fusion between resin microparticles, which promotes deformation. Further, performing the first ripening at a relatively low temperature for a short period can control deformation of core particles. Of the foregoing, time control of the first ripening step is most effective. The ripening step aims to control the circularity degree of associated particles and the associated particles become a shape close to a circle upon prolonging the ripening step.

There is further detailed preparation of the toner of the invention.

The core portion of toner particles is formed preferably as follows. A releasing agent component is dissolved or dispersed in a polymerizable monomer to form resin (A) and then mechanically dispersed in an aqueous medium to polymerize the monomer through mini-emulsion polymerization to form composite resin microparticles. The thus formed resin microparticles and colorant particles are subjected to salting-out (or coagulation)/fusion. When dissolving a releasing agent component in a monomer, the releasing agent component may be dissolved through dissolution or melting.

In the preparation of the core portion, a step of subjecting colorant particles and composite resin microparticles containing resin (A) obtained by multi-step polymerization to salting-out/fusion is conducted, for example, according to the following steps.

Dissolution/Dispersion Step:

In this step, a releasing agent compound is dissolved in a radical-polymerizable monomer to prepare a monomer solution containing a releasing agent.

Polymerization Step:

In one preferred embodiment of this step, the above-described monomer solution is added to an aqueous medium containing a surfactant at a concentration less than the critical micelle concentration (CMC) to form droplets, while providing mechanical energy. Subsequently, a water-soluble radical polymerization initiator is added thereto to promote polymerization within the droplets. An oil-soluble polymerization initiator may be contained in the droplets. In the polymerization step, providing mechanical energy is needed to perform enforced emulsification to form droplets. Means for providing mechanical energy include those for providing strong stirring or ultrasonic energy, for example, a homomixer, an ultrasonic homogenizer or a Manton-Gaulin homomixer.

Resin microparticles containing a binding resin and a mixture of ester compounds are obtained in the polymerization step. The resin microparticles may be colored microparticles or non-colored ones. Colored microparticles can be obtained by polymerization of a monomer composition containing a colorant. In the case when using non-colored microparticles, in the coagulation/fusion step, a dispersion of colorant particles is added to a dispersion of resin microparticles to allow the resin microparticles and the colorant particles to be fused to obtain colored particles.

Coagulation/Fusion Step (Including First Ripening):

A method for coagulation and fusion in the fusion step preferably is salting-out/fusion of resin microparticles (colored or non-colored resin microparticles) obtained in the above-described polymerization step. In the coagulation/fusion step, a particulate internal additive such as a releasing agent or a charge-controlling agent may be coagulated/fused together with resin microparticles and colorant particles.

The aqueous medium used in the coagulation/fusion step refers to a medium that is mainly composed of water (at 50% by weight or more). A component other than water is a water-soluble organic solvent. Examples thereof include methanol, ethanol, isopropanol, butanol, acetone, methyl ethyl ketone and tetrahydrofuran.

The colorant particles can be prepared by dispersing a colorant in an aqueous medium. Thus, a colorant is dispersed in an aqueous medium containing surfactants at a concentration in water at at least the critical micelle concentration (CMC). Dispersing machines used for dispersing the colorant are not specifically limited but preferably pressure dispersing machines such as an ultrasonic disperser, a mechanical homogenizer, a Manton-Gaulin homomixer or a pressure homogenizer, and a medium type dispersing machines such as a sand grinder, a Gettsman mil or a diamond fine mill. Usable surfactants include those described later. The colorant particles may be those which have been subjected to surface modification treatments. Surface modification of the colorant particles is affected, for example, in the following manner. A colorant is dispersed in a solvent and thereto, a surface-modifying agent is added and allowed to react with heating. After completion of the reaction, the colorant is filtered off, washed with the same solvent and dried to produce a surface-modified colorant (pigment).

The process of salting-out/fusion as a preferred method of coagulation/fusion is conducted, for example, in the following manner. To water containing resin microparticles and colorant particles is added an agent for salting out (hereinafter, also denoted as salting-out agent), e.g., alkali metal salts, alkaline earth metal salts or trivalent metal salts, at a concentration higher than the critical coagulation concentration. Subsequently, the mixture is heated at a temperature (° C.) higher than the glass transition temperature of the resin microparticles and also higher than the melting peak temperature to promote fusion concurrently with salting out. Of alkali metal salts and alkaline earth metal salts, alkali metals include, for example, lithium, potassium and sodium; and alkaline earth metals include magnesium calcium, strontium, and barium, of which potassium, sodium, magnesium, calcium and barium are preferred.

When performing coagulation and fusion through salting out and fusion, the mixture after adding a salting-out agent is permitted to stand preferably as short a time as possible. The reason therefor is not totally clear but there were produced problems such that the coagulation state of particles varied, the particle size distribution became unstable or the surface property of fused toner particles varied, depending on the standing time after being salted out. Addition of a salting-out agent needs to be conducted at a temperature lower than the glass transition temperature of the resin microparticles. The reason therefor is that addition of a salting-out agent at a temperature higher than the glass transition temperature promotes salting out and fusion of the resin microparticles but cannot control the particle size, resulting in formation of larger sized particles. The addition temperature, which is lower than the glass transition temperature, is usually in the range of 5 to 55° C., and preferably 10 to 45° C.

A salting-out agent is added at a temperature lower than the glass transition temperature of the resin microparticles and subsequently, the temperature is promptly increased to a temperature higher than the glass transition temperature of the resin microparticles and also higher than the melting peak temperature (° C.) of the mixture. The temperature is increased preferably over a period of less than 1 hr. The temperature needs to be promptly increased, preferably at a rate of 0.25° C./min or more. The upper temperature limit is not definite but instantaneously increasing the temperature abruptly causes salting out, rendering it difficult to control the particle size. The temperature is increased preferably at a rate of 5° C./min or less. In the fusion step, resin microparticles and any other particles are subjected to salting-out/fusion to obtain a dispersion of associated particles (core particles).

In the invention, the heating temperature in the coagulation/fusion step and the heating temperature and time in the first ripening step is so controlled that the formed core particles are in the shape of being rugged. Concretely, the coagulation/fusion step is conducted at a relatively low heating temperature to retard the progress of resin particles being fused to each other, which promotes deformation, or the first ripening is controlled at a low heating temperature for a short period so that the formed core particles are in the form of being rugged.

Shelling Step (Including Second Ripening):

In the shelling step, a dispersion of a particulate resin to be used for shelling is added to a dispersion of core particles and the resin particles for shelling coagulate and fuse with each other to permit the particulate resin to cover the surface of core particles, resulting in formation of colored particles.

Specifically, a core particle dispersion is added to a dispersion of resin particles for shelling, while maintaining the temperature in the coagulation/fusion step and the first ripening step and stirring with heating further continues for several hours, while the resin particles are permitted to cover the core particle surface to form colored particles. The time for stirring with heating is preferably 1 to 7 hrs., and more preferably 3 to 5 hrs. When the colored particles reach the prescribed size through shelling, a stopping agent such as sodium chloride is added thereto to stop growth of particles. Thereafter, stirring with heating continues further for several hours to permit the resin particles to fuse onto the core particles. In the shelling step, a 10 to 500 nm thick shell is formed on the core particle surface. Thus, resin particles are fixed by melting together onto the core particle surface to form a shell, whereby round, uniform colored particles are formed.

In the invention, round, uniform toner particles can be prepared by completing the foregoing step. Further, the shape of colored particles can be controlled to be close to a sphere by extending the second ripening time or by raising the ripening temperature.

Cooling Step:

This step refers to a stage that subjects a dispersion of the foregoing colored particles to a cooling treatment (rapid cooling). Cooling is performed at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

Solid-Liquid Separation and Washing Step:

In the solid-liquid separation and washing step, a solid-liquid separation treatment of separating colored particles from a colored particle dispersion is conducted, then cooled to the prescribed temperature in the foregoing step and a washing treatment for removing adhered material such as a surfactant or salting-out agent from a separated toner cake (wetted aggregate of colored particles aggregated in a cake form) is applied. In this step, a filtration treatment is conducted, for example, by a centrifugal separation, filtration under reduced pressure using a Nutsche funnel or filtration using a filter press, but is not specifically limited.

Drying Step:

In this step, the washed toner cake is subjected to a drying treatment to obtain dried colored particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried colored particles is preferably not more than 5% by weight, and more preferably not more than 2%. When colored particles that were subjected to a drying treatment are aggregated via a weak attractive force between particles, the aggregate may be subjected to a pulverization treatment. Pulverization can be conducted using a mechanical pulverizing device such as a jet mill, Henschel mixer, coffee mill or food processor.

External Addition Treatment:

In this step, the dried colored particles are optionally mixed with external additives to prepare a toner. There are usable mechanical mixers such as a Henschel mixer and a coffee mill.

Polymerization initiators, chain-transfer agents and surfactants usable in the preparation of the toner of the invention will be described below.

Resin constituting the core and the shell of toner particles relating to the invention can be prepared by polymerization of polymerizable monomers. Radical polymerization initiators usable in the invention are those described below. Specifically, when forming resin particles through emulsion polymerization, oil-soluble polymerization initiators are usable. Examples of an oil-soluble polymerization initiator include azo- or diazo-type polymerization initiators, e.g., 2,2′-azobis-(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile, azobisisobutylonitrile; peroxide type polymerization initiators, e.g., benzoyl peroxide, methyl ethyl ketone peroxide, diisopropylperoxycarbonate, cumene hydroperoxide, t-butyl hyroperoxide, di-t-butyl peroxidedicumyl peroxide, 2,4-dichlorobenzoyl peroxide, lauroyl peroxide, 2,2-bis-(4,4-t-butylperoxycyclohexyl)-propane, tris-(t-butylperoxy)triazine; and polymeric initiators having a side-chain of peroxide.

Water-soluble radical polymerization initiators are usable when forming particulate resin through emulsion polymerization. Examples of a water-soluble polymerization initiator include persulfates such as potassium persulfate and ammonium persulfate; azobisaminodipropane acetic acid salt, azobiscyanovaleric acid and its salt, and hydrogen peroxide.

Dispersion stabilizers are also usable for moderate dispersion of polymerizable monomers in a reaction system. Examples of a dispersion stabilizer include calcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina. Further, polyvinyl alcohol, gelatin, methylcellulose, sodium dodecybenzenesulfate, ethylene oxide adduct, sodium higher alcohol-sulfate and the like, which are generally usable as a surfactant, are also usable as a dispersion stabilizer.

Conventionally used chain-transfer agents are usable for the purpose of adjustment of the molecular weight of resin constituting composite resin particles. Chain-transfer agents are not specifically limited and examples thereof include mercaptans such as octylmercaptan, dodecylmercaptan and tert-dodecylmercaptan; n-octyl-3-mercaptopropionic acid ester; terpinolene; carbon tetrabromide and α-methylstyrene dimmer.

Surfactant usable in the invention are described as follows.

To perform polymerization using radical-polymerizable monomers, surfactants are used to disperse such monomers in the form of oil droplets in an aqueous medium. Surfactants usable therein are not specifically limited but ionic surfactants described below are preferred. Such ionic surfactants include sulfates (e.g., sodium dodecylbenzenesulfate, sodium arylalkylpolyethersulfonate, sodium 3,3-disulfondisphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate) and carboxylates (e.g., sodium oleate, sodium laurate, sodium caprate, sodium caprylate, sodium caproate, potassium stearate, calcium oleate).

Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid, and sorbitan ester.

The weight-average particle size (dispersion particle size) of composite resin particles is preferably in the range of 10 to 1,000 nm, and more preferably 30 to 300 nm. The weight-average particle size can be determined using the electrophoresis light scattering photometer ELS-800 (produced by Otsuka Denshi Co.).

Toners relating to the invention may be a monocomponent toner or a two-component toner, but specifically preferred is a nonmagnetic monocomponent toner.

Next, image forming methods in which the toner of the invention are usable will be described. Toners relating to the invention are suitably used in a high-speed image forming apparatus, for example, at a level of printing rate of at least 400 mm/sec (output performance of 85 A4-sheet/min), and preferably at least 490 mm/sec. Specific examples thereof include a printer capable of making a lot of documents on demand for a short period. The toner of the invention is also applicable to an image forming method using a fixing roller at a temperature of 150° C. or less, and preferably 130° C. or less.

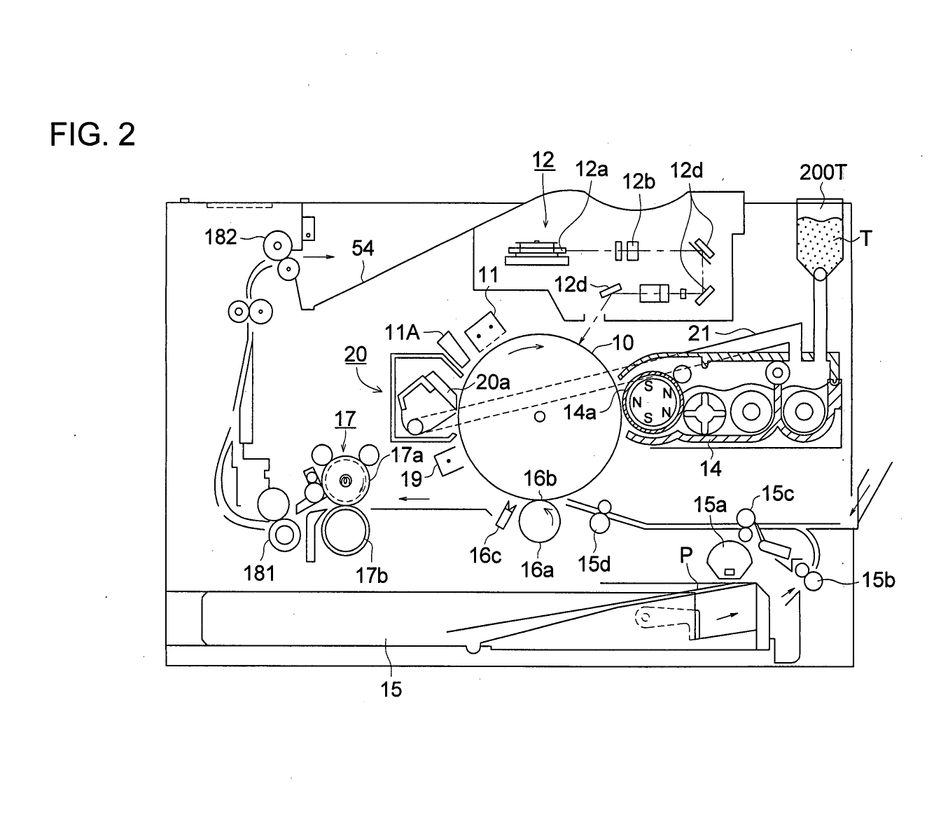

FIG. 2 illustrates an example of an image forming apparatus capable of using the toner of the invention, showing a sectional view thereof.

FIG. 2 shows an image forming apparatus having a conveyance route of a recovered toner, corresponding to a toner recycling means in which after completing the transfer step, a toner remaining on the photoreceptor is recovered by a cleaning means and the recovered toner is supplied to a developing device and recycled.

In FIG. 2, the numeral 10 is a photoreceptor drum of an electrostatic latent image carrier, for example, a conductive drum having, thereon, coated an organic photoreceptor (OPC photoreceptor), which is earthed and clockwise rotatable. The numeral 11 is a scorotron charger which becomes negatively charged uniformly on the circumferential surface of the photoreceptor drum 10 by corona discharge to provide a potential of VH. Before being charged by the scorotron charger 11, the circumferential surface of a photoreceptor needs to be neutralized to remove the history up to the preprints, so that the circumferential surface is exposed to light and neutralized by PCL11A as a light exposure means before being charged.

After being uniformly charged onto the photoreceptor drum 10 by the scorotron charger 11, imagewise exposure is performed based on image signals by laser writing device 12 as an imagewise exposure means. Image signals inputted from a computer or an image reading device are processed in image signal processing unit and inputted into the laser writing device 12, performing imagewise exposure to form an electrostatic latent image on the photoreceptor drum 10.

The laser writing device 12 employs, as an emission light source, a laser diode (not shown in the drawing) and performs main scanning by plural reflection mirrors 12d via rotary polygon mirror 12a and fθ lens 12b, and subscanning is performed by rotation of the photoreceptor 10 to form an electrostatic latent image. In the examples, exposure is performed based on the foregoing image signals to form a reverse latent image exhibiting a low absolute potential value in exposed areas.

Developing device 14 as a developing means occluding a two-component developer composed of a negative-charged conductive toner relating to the invention and a magnetic carrier, is provided on the periphery of the photoreceptor 10. Toner T is supplied from toner containing vessel 200T to the developing device 14. In the developing device 14, a developer is held by an occluded magnet body and reversal development is performed by rotating development sleeve 14a to form a toner image on the photoreceptor drum 10. The formed toner image on the photoreceptor 10 is transferred onto transfer material P by transfer roller 16a as a transfer means. The transfer material P is conveyed from transfer material-containing vessel 15 to the transferred region by feed roller 15a and conveyance rollers 15b, 15c and 15d.

Subsequently, transfer material P having a transferred image thereon, is neutralized by peak electrode 16c which is arranged by a slight gap, separated from the circumferential surface of the photoreceptor drum 10 and conveyed to fixing device 17 as a fixing means. In the fixing device 17, a toner image is melted by heating and pressure from heating roller 17a and pressure roller 17b, fixed onto transfer material P then discharged to tray 54 by discharging rollers 181 and 182.

The transfer roller 16a is evacuated and separated from the circumferential surface of the photoreceptor drum 10 over a period from passage of the transfer material P to the next toner image transfer.

The photoreceptor drum 10 which has transferred a toner image onto the transfer material P, is neutralized by charge neutralizer 19, then, a residual toner is removed by cleaning device 20 corresponding to the cleaning means for the photoreceptor. Thus, the residual toner on the circumferential surface is scraped off by cleaning blade 20a formed by a rubber material in contact with the photoreceptor drum 10, to the interior of cleaning device 20. The scraped recovery toner is conveyed through recovery toner transfer route 21 which is provided with a screw and the like, to the developing device 14.

The photoreceptor drum 10, the residual toner on which has been removed by the cleaning device 20 is exposed to light by PCL11A and uniformly charged by the charger 11 to enter the next image forming cycle.

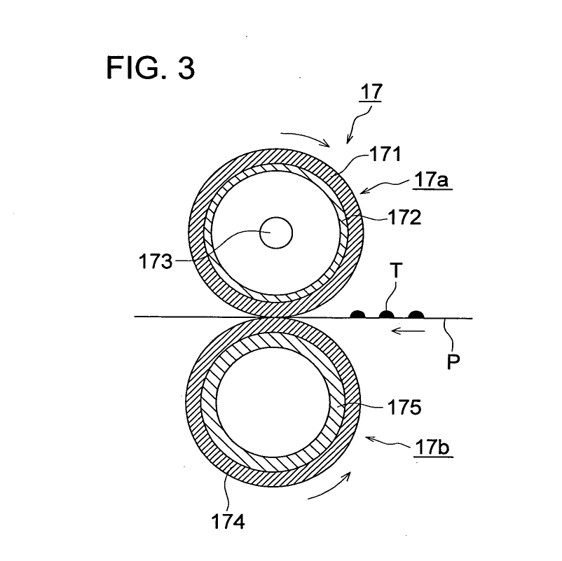

FIG. 3 shows a sectional view of one example of the fixing device 17 usable in the image forming apparatus shown in FIG. 2, which is provided with heating roller 17a in contact with pressure roller 17b. In FIG. 3, T designates a toner image formed on transfer paper P (image forming support).

In the heating roller 17a, cover layer 171 composed of fluororesin or elastic material is formed on the surface of core 172, in which heating member 173 formed of linear heaters is enclosed.

The core 172 is constituted of a metal having an internal diameter of 10 to 70 mm. The metal constituting the core 172 is not specifically limited, including, for example, a metal such as aluminum or copper and its alloys. The wall thickness of the core 172 is in the range of 0.1 to 15 mm and is determined by taking into account the balancing of the requirements of energy-saving (thinned wall) and strength (depending on constituent material). To maintain the strength equivalent to a 0.57 mm thick iron core by an aluminum core, for instance, the wall thickness thereof needs to be 0.8 mm.

Examples of fluororesin constituting the cover layer 171 include polytetrafluoroethylene (PTFE) and tetraethylene/perfluoroalkyl vinyl ether copolymer (PFA).

The thickness of the cover layer 171 composed of fluororesin is usually 10 to 500 μm, and preferably 20 to 400 μm. Examples of elastic material constituting the cover layer 171 include silicone rubber exhibiting superior heat-resistance, such as LTV, RTV and HTV and silicone sponge rubber. The Asker C hardness of an elastic material constituting the cover layer 171 is less than 80°, and preferably less than 60°. The thickness of the cover layer 171 composed of elastic material is usually 0.1 to 30 mm, and preferably 0.1 to 20 mm.

The heating member 173 preferably uses a halogen heater.

The pressure roller 17b is constituted of cover layer 174 composed of an elastic material, formed on core 175. The elastic material constituting the cover layer 174 is not specifically limited, and examples thereof include soft rubber such as urethane rubber or silicone rubber and sponge. The use of silicone rubber or silicone sponge in the cover layer 174 is preferred. The Asker C hardness of an elastic material constituting the cover layer 174 is usually less than 80°, preferably less than 70°, and more preferably less than 60°. The thickness of the cover layer 174 is usually 0.1 to 30 mm, and preferably 0.1 to 20 mm.

Material constituting the core 175 is not specifically limited and examples thereof include metals such as aluminum, iron and copper and the alloys of these metals.

The combined load (total load) of the heating roller 17a and the pressure roller 17b is usually in the range of 40 N to 250 N, preferably 50 N to 300 N, and more preferably 50 N to 250 N. The combined load is restricted by taking into account the strength of the heating roller 17a (wall thickness of the core 172); for instance, in the case of a heating roller having a 0.3 mm thick iron core, the combined load is preferably not more than 250 N.

The nip width is preferably in the range of 4 to 10 mm in terms of off set resistance and fixability. The surface pressure of the nip is preferably in the range of 0.6×10⁵ to 1.5×10⁵ Pa.

The image forming apparatus relating to the invention may employ a fixing device of an induction heating system, in place of a fixing device of a heating roll system.

Transfer material P used in the invention is a support holding toner images and is one which is usually called an image support, recording material or transfer paper. Specific examples thereof include plain paper or fine-quality paper including thin paper and heavy paper, coated paper for graphic art such as art paper or coated paper, commercially available Japanese paper and post card paper and various kinds of transfer materials such as plastic film for OHP and cloth.

### EXAMPLES

The present invention is further described by reference to the following specific examples but the embodiments of the invention are by no means limited thereto.

### Preparation of Toner

Preparation of Resin Microparticles for Core:

A monomer composition, as described below was placed into a stainless steel vessel fitted with a stirrer and further thereto, 100 g of pentaerythritol tetrabehenate was added and dissolved with heating at 70° C. to prepare a monomer solution.

| | |
|---|---|
| Styrene | 175 g |
| n-Butylacrylate | 60 g |
| Methacrylic acid | 15 g |
| n-Octyl-3-mercaptopropionate | 7 g |

Subsequently, a surfactant solution of 2 g of polyoxyethylene dodecyl ether sodium sulfate (two mole adduct of ethylene oxide) dissolved in 1350 g of deionized water was heated to 70° C., added to the above-described monomer solution and dispersed at 70° C. for 30 min, using a mechanical dispersant provided with a circulation path, CLEARMIX (produced by M Technique Co., Ltd.) to obtain an emulsified dispersion.

Further to the emulsified dispersion was added an initiator solution of 7.5 g of potassium persulfate dissolved in 150 g of deionized water and this reaction system was stirred with heating at 78° C. for 1.5 hr. to perform polymerization to obtain a dispersion of resin microparticles. The obtained dispersion was designated resin microparticle dispersion 1.

To the resin microparticle dispersion 1 was added an initiator solution of 12 g of potassium persulfate dissolved in 220 g of deionized water and heated to 80° C. Under the same temperature condition was dropwise added the following monomer mixture over a period of 1 hr.:

| | | |
|---|---|---|
| Styrene | 320 | g |
| n-Butylacrylate | 100 | g |
| Methacrylic acid | 35 | g |
| n-Octyl-3-mercaptopropionate | 7.5 | g |

After completion of addition, stirring continued for 2 hr. with heating to perform polymerization. Thereafter, the reaction mixture was cooled to 28° C. to obtain a dispersion of resin microparticles for the core. The obtained dispersion was designated resin microparticle dispersion for core.
Dispersion of Particulate Colorant:

To 1600 g of deionized water was added 90 g of sodium dodecylsulfate with stirring and further thereto, 400 g of carbon black (Regal 330R, produced by Cabot Co.) was gradually added to obtain a mixture. The mixture was subjected to a dispersing treatment, using a mechanical dispersant, CLEARMIX (produced by M Technique Co., Ltd.) to obtain a dispersion of colorant particles. The obtained colorant dispersion was measured with respect to particle size, using electrophoresis light scattering photometer ELS-800 (produced by Otsuka Denshi Co.). The average particle size of the colorant particles was 110 nm.

Preparation of Composite Resin Particles for Core:

To a reaction vessel fitted with a temperature sensor, a condenser, a nitrogen gas-introducing device and stirrer was added the composition described below with stirring to obtain a dispersion of associated particles. The obtained dispersion was adjusted to 30° C. and then adjusted to a pH of 10 with an aqueous 5 M/L sodium hydroxide solution.

| | |
|---|---|
| Resin microparticle dispersion for core | 2000 g |
| Deionized water | 670 g |
| Colorant dispersion | 400 g |

Subsequently, to the associated particle dispersion was added an aqueous solution of 60 g of magnesium chloride hexahydrate dissolved in 60 g of deionized water, at 30° C. for 10 min. with stirring.

After allowed to stand for 3 min., temperature raising was started and this system was raised to a temperature of 80° C. over 60 min. to perform particle association to grow particles, while monitoring the size of associated particles by Coulter Multisizer III. When the particle size reached a volume-base median diameter of 5 μm, an aqueous solution of 8.5 g of sodium chloride dissolved in 35 g of deionized water was added thereto to stop particle growth.

Further, ripening was carried out at 85° C. for 120 min. with stirring to obtain composite resin particle dispersion 1 for core use. The shape factor (SF-2) of the obtained composite resin particle 1 is shown in Table 1

Preparation of Resin Particles for Shell:

To a stainless steel vessel (SUS vessel) fitted with a stirrer, a temperature sensor, a condenser and a nitrogen gas-introducing device was added a surfactant solution of 8 g of sodium dodecylsulfate, dissolved in 3000 g of deionized water and the liquid temperature was raised to 80° C. while stirring at a rate of 230 rpm under nitrogen gas stream. To the surfactant solution was added an initiator solution of 10 g of potassium persulfate, dissolved in 200 g of ionized water. After the temperature was raised to 80° C., the following monomer solution was dropwise added thereto over 100 min. This system was stirred with heating at 80° C. for 2 hr. to prepare a dispersion of resin particles for use in shell.

| | | |
|---|---|---|
| Styrene | 570 | g |
| n-Butylacrylate | 165 | g |
| Methacrylic acid | 70 | g |
| n-Octyl-3-mercaptopropionate | 5.5 | g |

Preparation of Colored Particle 1:

To the composite resin particle dispersion 1 for core use was added the dispersion of resin particles for use in the shell and stirred with heating for 4 hr. to permit resin particles for shell use to be coagulated and fused onto the surface of resin core particles. Thereto was added 17 g of sodium chloride to stop the growth of particles. Further, heating at 97° C. with stirring continued for 2 hr. to perform ripening of the shell. Thereafter, the temperature was lowered to 30° C. and the pH was adjusted to 2.0 with hydrochloric acid and stirring was stopped. Formed colored particles were filtered and repeatedly washed with deionized water of 45° C., and dried with hot air of 40° C. to obtain colored particles 1 having a core/shell structure.

Preparation of Toner 1:

To the above-obtained colored particles (1) having a core/shell structure were added 1% by weight of hydrophobic silica (number-average primary particle size of 12 nm, degree of hydrophobicity of 68) and 0.3% by weight of hydrophobic titanium oxide (number-average primary particle size of 20 nm, degree of hydrophobicity of 63) with stirring by Henschel mixer to obtain toner 1. In Table 1 are shown physical properties of the toner 1, including shape factors (SF-1 and SF-2) and the standard deviation thereof, the maximum shell thickness (Lmax) and minimum shell thickness (Lmin).

Preparation of Toners 2-5 and 7:

Toners 2-5 and 7 were each prepared similarly to the toner 1, provided that the ripening time (stirring/heating time) of composite resin particles for the core, and the coagulation/fusion time and ripening time of resin particles for shell were varied as shown in Table 1. Physical properties of the obtained toners 2-5 and 7 are shown in Table 1.

Preparation of Toner 6:

Toners 6 was prepared similarly to the toner 1, provided that the ripening time (stirring/heating time) of composite resin particles for core, and the coagulation/fusion time and ripening time of resin particles for shell were varied as shown in Table 1, and coagulation and ripening temperatures of composite resin particles were each changed to 90° C. Physical properties of the obtained toner 6 are shown in Table 1.

Preparation of Toner 8 (Emulsion Polymerization Toner):

| | |
|---|---|
| Styrene | 165 g |
| n-Butylacrylate | 35 g |
| Carbon black | 10 g |
| Styrene/methacrylic acid copolymer | 8 g |
| Paraffin wax (mp = 70° C.) | 20 g |

The above-described composition was dissolved and homogeneously dispersed, while heating at 60° C. and stirring by TK homomixer (produced by Tokushukika-kogyo Co., Ltd.) at 12,000 rpm. Thereto, 10 g of 2,2′-azobis(2,4-valeronitrile) was added and dissolved to prepare polymerizable monomer composition. Subsequently, 450 g of a 0.1 M sodium phosphate aqueous solution was added to 710 g of deionized water and 68 g of a 1.0 M calcium chloride aqueous solution was gradually added thereto with stirring by a TK homomixer at 13,000 rpm to obtain a suspension. To the obtained suspension, the above monomer composition was added and stirred by a TK homomixer at 10,000 rpm for 20 min. to granulate the monomer composition. Then, reaction was performed at 80° C. for 10 hr. to obtain a dispersion of core particles having a median diameter of 7.5 μm. Then. 1.0 g of benzoyl peroxide was added and dissolved therein. Further, the following composition was dropwise added at 80° C. over a period of 3 hr. and the reaction was continued for 10 hr. to complete polymerization:

| | | |
|---|---|---|
| Styrene | 30 | g |
| n-Butylacrylate | 10 | g |
| Methacrylic acid | 1 | g |
| n-Octyl-3-mercaptopropionate | 1 | g. |

After allowed to stand to cool, the reaction mixture was treated with hydrochloric acid, filtered, washed and dried to obtain colored particles of core/shell structure. From transmission electron-micrographs, the toner 8 was proved to exhibit a structure, as shown in FIG. 1c.

In Table 1 are shown a volume-base median diameter (μm), denoted as D50, average shape factors (SF-1) and (SF-2), standard deviations of shape factors SF-1 and SF-2 and shell layer thickness of toners 1-8. From transmission electron-microscopic observation with respect to the structure of the toners, it was proved that toners 1-5 exhibited a structure, as shown in FIG. 1a and toner 6 and 8 exhibited a structure as shown in FIG. 1c. It was proved that toner 7 exhibited a shell of more non-uniform structure than the structure shown in FIG. 1a.

TABLE 1

| | Composite | | | | | | | | | | | | |
|---|---|---|---|---|---|---|---|---|---|---|---|---|---|
| | Resin Particle | | Resin Particle | | | | | | | | | | |
| | for Core | | for Shell | | | Characteristic of Toner | | | | | | | |
| | Ripening | Shape | | C/S | | | Roundness | | Ruggedness | | Shell Thickness (nm) | | |
| Toner | Time | Factor | Amount | Time*¹ | Ripening | D50 | (SF-1) | | (SF-2) | | | | (Lmax)/ |
| No. | (min) | (SF-2) | (g) | (hr) | Time (hr) | (μm) | (SF-1) | S.D.*² | (SF-2) | S.D.*² | (Lmax) | (Lmin) | (Lmin) |
| 1 | 120 | 4.0 | 530 | 4.0 | 2.0 | 5.3 | 1.30 | 0.10 | 1.28 | 0.10 | 350 | 35 | 10.0 |
| 2 | 60 | 5.0 | 530 | 4.0 | 2.0 | 5.3 | 1.30 | 0.10 | 1.28 | 0.15 | 480 | 12 | 40.0 |
| 3 | 180 | 2.0 | 530 | 3.5 | 1.5 | 5.4 | 1.26 | 0.10 | 1.25 | 0.10 | 130 | 85 | 1.5 |
| 4 | 30 | 10.0 | 530 | 4.5 | 1.5 | 5.3 | 1.27 | 0.13 | 1.35 | 0.12 | 500 | 10 | 50.0 |
| 5 | 10 | 12.0 | 265 | 3.5 | 2.0 | 5.1 | 1.27 | 0.16 | 1.40 | 0.17 | 80 | 10 | 8.0 |
| 6 | 360 | 1.5 | 530 | 4.0 | 2.0 | 5.4 | 1.30 | 0.10 | 1.28 | 0.10 | 200 | 150 | 1.3 |
| 7 | 10 | 12.0 | 530 | 0.5 | — | 5.3 | 1.31 | 0.20 | 1.40 | 0.21 | 600 | 11 | 54.5 |
| 8 | — | — | — | — | — | 8.1 | 1.18 | 0.25 | 1.15 | 0.25 | 390 | 280 | 1.4 |

*¹/fusion time,
*²standard deviation

Preparation of Developer:

Each of the toners described in Table 1 was mixed with a silicone resin-coated ferrite carrier of volume-average particle size of 50 μm to prepare a developer having a toner content of 6%, as shown in Table 2.

### Evaluation

Apparatus for Evaluation:

Commercially available image forming apparatus, bizhub PRO 1050 (produced by Konica Minolta Corp.) was employed for evaluation, provided that fixing was done at a rate of 490 mm/sec, corresponding to ca. 85 sheet/min (A4-size, transverse feeding) and the surface temperature of a heating roll was varied.

Fixability (Offset Resistance):

An unfixed solid black image of 30 mm width was formed on copy paper with a 5 mm blank space on the top portion thereof. The thus formed unfixed image was fixed with varying a fixing temperature at intervals of 5° C. in the range of 110 to 230° C. to determine the lowest limit of temperature at which no winding occurred upon fixing (i.e., lowest temperature for non-offset).

Fixing Ratio:

A solid black image was formed at a toner coverage of 0.6 g/cm², and transferred onto fine-quality paper of a thickness of 200 g/m² and fixed using the fixing device above-described to prepare an image sample to evaluate a fixing ratio.

A solid black image of 2.5 cm square was taken out the image sample and Scotch mending tape (produced by Sumitomo 3M Co., Ltd.) was adhered thereto. Image densities were determined before and after peeling the tape and the fixing ratio was determined according to the following equation:
Fixing ratio (%)=[(image density after peeling)/(image density before peeling)]×100
The image density was measured using Macbeth reflection densitometer RD-918 (Macbeth Co.). A fixing ratio of 80% or more was judged to be acceptable.
Image Evaluation (Fogging Evaluation):

Image formation was performed over 100,000 sheets of A4 with respect to an image, with a pixel rate of 10% (an original image composed of a text image with a pixel rate of 7%, a portrait photograph, a solid white image and a solid black image, each accounting for ¼ equal part). A fog density was determined as follows. Absolute image densities of 20 points on non-printed white paper were measure using Macbeth reflection densitometer RD-918 and the average value thereof was defined as a blank paper density. Next, in the white background of 100,000th printed sheet, absolute image densities of 20 points were measured and averaged out. The thus obtained average density minus the foregoing blank paper density was defined as a fog density.

A fog density of not more than 0.010 is acceptable in practice. Fogging was evaluated based on the following criteria:

A: a fog density not more than 0.003,

B: a fog density of not more than 0.006 and more than 0.003,

C: a fog density of not more than 0.010 and more than 0.006,

D: a fog density of more than 0.010.

Results are shown in Table 2.

TABLE 2

| | Toner No. | Lowest | | |
|---|---|---|---|---|
| Example | (Developer | Temperature for | Fixing | |
| No. | No.) | Non-offset (° C.) | Ratio (%) | Fogging |
| Example 1 | 1 | 115 | 92 | A |
| Example 2 | 2 | 115 | 95 | A |
| Example 3 | 3 | 120 | 85 | A |
| Example 4 | 4 | 115 | 88 | B |
| Example 5 | 5 | 115 | 90 | C |
| Comp. 1 | 6 | 125 | 70 | B |
| Comp. 2 | 7 | 125 | 81 | D |
| Comp. 3 | 8 | 130 | 83 | D |

Further, evaluation was similarly conducted at a fixing rate of 400 mm/sec and results similar to the case when fixed at a fixing rate of 490 mm/sec were obtained.

As can be seen from the foregoing results, high-speed image formation was conducted using toners according to the invention, in which the lowest temperature for non-offset was low and the fixing ratio was enhanced, leading to superior low temperature fixability. It was proved that fogging was reduced and superior image formation was achieved.

What is claimed is:

1. An electrostatic image developing toner comprising toner particles each comprising a core containing at least a resin and a colorant and having thereon a shell containing a resin, wherein the toner particles exhibit a standard deviation of shape factor SF-1 of 0.05 to 0.20 and a standard deviation of shape factor SF-2 of 0.05 to 0.20, and the toner particles meeting the following requirement:
1.5≦(Lmax)/(Lmin)≦50.0
wherein (Lmax) is an average of maximum thickness of the shell of the toner particles and (Lmin) is an average of minimum thickness of the shell,
and wherein the shape factor SF-1 and the shape factor SF-2 of the toner particles are defined by the following equation:
SF-1=[(maximum diameter of toner particle)²/(projected area of toner particle)]×(π/4)
SF-2=[(circumference of toner particle)²/(projected area of toner particle)]×(1/4π).

2. The toner of claim 1, wherein the standard deviation of shape factor SF-1 and the standard deviation of shape factor SF-2 are each from 0.10 to 0.15.

3. The toner of claim 1, wherein the shape factor SF-1 and the shape factor SF-2 each exhibit an average value of from 1.10 to 1.50.

4. The toner of claim 1, wherein the toner particles meet the following requirement:
10.0≦(Lmax)/(Lmin)≦40.0

5. The toner of claim 1, wherein a value of (Lmax) is from 100 to 500 nm.

6. The toner of claim 1, wherein a value of (Lmin) is from 10 to 100 nm.

7. The toner of claim 1, wherein the toner particles meet the following requirement:
(shape factor SF-2 of core)>(shape factor SF-2 of toner particle)
wherein (shape factor SF-2 of core) is an average shape factor SF-2 of the core of the toner particles and (shape factor SF-2 of toner particle) is an average shape factor SF-2 of the toner particles.

8. The toner of claim 7, wherein a value of (shape factor SF-2 of core) is from 2.0 to 10.0.

9. The toner of claim 1, wherein a weight ratio of the shell to the core of the toner particles is from 10% to 30%.

10. The toner of claim 1, wherein a thickness of the shell is from 10 to 500 nm.

11. The toner of claim 1, wherein a glass transition point of the resin contained in the core is lower than that of the resin contained in the shell.

12. The toner of claim 1, wherein a softening point of the resin contained in the core is lower than that of the resin contained in the shell.

13. The toner of claim 1, wherein the resin contained in the core exhibits a weight-average molecular weight of 0.3×10⁴ to 4×10⁴ and the resin contained in the shell exhibits a weight-average molecular weight of 0.8×10⁴ to 20×10⁴.

14. The toner of claim 1, wherein the toner particles exhibit a volume-based median diameter of 2.0 to 7.0 μm

15. The toner of claim 1, wherein the toner particles exhibit an average circularity of 0.920 to 0.975.
